(19) United States
(12) Patent Application Publication
(10) Pub. No.: US 2007/0222873 A1
(43) Pub. Date: Sep. 27, 2007

(54) Signal Compensation Circuit and Related Method for Correcting DC Offsets in An Analog Manner

(76) Inventor: Yen-Cheng Chen, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 11/690,855

(22) Filed: Mar. 26, 2007

(30) Foreign Application Priority Data
Mar. 27, 2006 (TW) 095110590

(51) Int. Cl. H04N 5/16

(52) U.S. Cl. 348/257

(57) ABSTRACT

A signal compensation circuit for correcting DC offsets in an analog manner includes a storage unit, a multiplexer, and an arithmetic unit. The storage unit is used for storing a plurality of offset-correcting signals. The multiplexer includes at least two input ends coupled to the storage unit, each input end used for receiving an offset-correcting signal. The multiplexer includes at least one control end receiving a selector signal for selecting one offset-correcting signal from the plurality of offset-correcting signals received according to the selector signal. A first input end of the arithmetic unit is coupled to an output end of the multiplexer for receiving the selected offset-correcting signal, and a second input end of the arithmetic unit receives an image signal. The arithmetic unit executes a compensation operation based on the analog signals received at the two input ends of the arithmetic unit.

### BACKGROUND OF THE INVENTION

1. Field of the Invention

The present invention relates to a signal compensation circuit and related method, and more particularly, to a signal compensation circuit and related method providing offset-correcting signals in accordance with different charge-coupled devices or other image sensors in general.

2. Description of the Prior Art

A charge-coupled device is an optical electronic component for converting optical signals into electronic signals and processing electronic signals in an analog manner. The usage of charge-coupled devices is widespread, such as in monitors, recording devices, and cameras. The characteristics of the charge-coupled device are that it has high resolution, low noise, and extreme high sensibility. Another popular optical electronic component is a CMOS photodiode. The application range of COMS photodiode includes PC cameras, image phones, automobile reverse radars, and digital cameras.

Charge-coupled devices can be categorized into two types: presently, the linear CCD and the area CCD. The main usage of a liner CCD includes fax machines, scanners, and multi-function printers. The application range of an area CCD focuses on camcorders and digital cameras.

Please refer to FIG. 1. FIG. 1 is a diagram of a conventional charge-coupled device 10. The charge-coupled device 10 includes a plurality of image-sensing elements P1-Pn, an analog shift register 12, and an output amplifier OP. The plurality of image-sensing elements P1-Pn is used for sensing optical signals and generating corresponding electric charges. The analog shift register 12 is coupled to the plurality of image-sensing elements P1-Pn. The analog shift register 12 includes a plurality of shift register elements SH₁-SH₂ₙ used for storing electric charges generated by the plurality of image-sensing elements P1-Pn. The output amplifier OP is coupled to the analog shift register 12 for converting electric charges outputted from the analog shift register 12 into a corresponding voltage level V0. Each image-sensing element corresponds with two shift register elements. For example, the image-sensing element P1 corresponds with the shift register elements SH₁ and SH₂. The image-sensing element P2 corresponds with the shift register elements SH₃ and SH₄. Reason by analogy, the image-sensing element Pn corresponds with the shift register elements SH₂ₙ₋₁ and SH₂ₙ. The analog shift register 12 is controlled by two clock signals φ1 and φ2 for shifting electric charges stored in the plurality of shift register elements SH₁-SH₂ₙ serially to the output amplifier OP.

Please refer to FIG. 2, a structural drawing illustrating the plurality of shift register elements SH₁-SH₂ₙ in FIG. 1. The plurality of shift register elements SH₁-SH₂ₙ includes a plurality of shift gate electrodes G1-G5 for storing electric charges and a semiconductor substrate Psub coupled to the plurality of shift gate electrodes G1-G5 (only five shift gate electrodes G1-G5 are shown in FIG. 2). Each shift gate electrode and the semiconductor substrate Psub form a shift register element. The shift register elements SH₁-SH₂ₙ are controlled by the clock signals φ1 and φ2. Due to the shift gate electrodes G1-G5 having different potential barriers at different times, electric charges will shift to the shift gate electrode with lower potential barrier. Finally, all electric charges are outputted to the output amplifier OP (as shown in FIG. 1).

Please refer to FIG. 3, a diagram of an even-odd charge-coupled device 30 according to the prior art. The even-odd charge-coupled device 30 includes a plurality of image-sensing elements P1-Pn, two analog shift registers 32 and 34, and two output amplifiers OP1 and OP2. The plurality of image-sensing elements P1-Pn is used for sensing optical signals and generating corresponding electric charges. The analog shift register 32 is coupled to odd image-sensing elements, such as P1 and P3-P(n−1). The analog shift register 32 includes a plurality of odd shift register elements SH₁ₐ, SH_{1b}, SH₃ₐ, SH_{3b}, . . . , SH₍ₙ₋₁₎ₐ, and SH_{(n-1)b}. These odd shift register elements are used for storing electric charges generated by the plurality of odd image-sensing elements P1, and P3-P(n−1). The output amplifier OP1 is coupled to the analog shift register 32 for converting electric charges outputted from the analog shift register 32 into corresponding voltage level V1.

The analog shift register 34 is coupled to even image-sensing elements, such as P2 and P4-Pn. The analog shift register 34 includes a plurality of even shift register elements SH₂ₐ, SH_{2b}, SH₄ₐ, SH_{4b}, . . . , SHₙₐ, and SH_{nb}. These even shift register elements are used for storing electric charges generated by the plurality of even image-sensing elements P2, and P4-Pn. The output amplifier OP2 is coupled to the analog shift register 34 for converting electric charges outputted from the analog shift register 34 into an output signal with corresponding voltage level V2. Each image-sensing element corresponds with two shift register elements. For example, the photo diode cell P1 corresponds with the shift register elements SH₁ₐ and SH_{1b}. The image-sensing element P2 corresponds with the shift register elements SH₂ₐ and SH_{2b}. Reason by analogy, the image-sensing element Pn corresponds with the shift register elements SHₙₐ and SH_{nb}. The analog shift register 32 is controlled by two clock signals φ11 and φ12 for shifting electric charges stored in the plurality of odd shift register elements SH₁ₐ-SH₍ₙ₋₁₎ₐ and SH_{1b}-SH_{(n-1)b} serially to the output amplifier OP1. The odd shift register elements SH₁ₐ-SH₍ₙ₋₁₎ₐ are controlled by the clock signal φ11, and the odd shift register elements SH_{1b}-SH_{(n-1)b} are controlled by the clock signal φ12. The analog shift register 34 is controlled by two clock signals φ21 and φ22 for shifting electric charges stored in the plurality of even shift register elements SH₂ₐ-SHₙₐ and SH_{2b}-SH_{nb} serially to the output amplifier OP2. The even shift register elements SH₂ₐ-SHₙₐ are controlled by the clock signal φ21, and the even shift register elements SH_{2b}-SH_{nb} are controlled by the clock signal φ22.

Please refer to FIG. 4, a diagram of a conventional signal compensation circuit 40. The output signal generated from the charge-coupled device usually contains an image component that is attributable to the exposure of the image-sensing elements P1-Pn to light. However, the output signal also contains an unwanted DC offset component that is attributable to the inherent operating characteristics of the charge-coupled device. It is necessary to amplify the image component of the output signal and to remove the unwanted DC offset component. Thus, a signal compensation circuit for correcting the DC offset would be required. The signal compensation circuit 40 includes a storage unit 46, a digital-to-analog converter 47, and an adder 48. The storage unit 46 is used for storing an offset-correcting signal DC0. An input end 472 of the digital-to-analog converter 47 is coupled to the storage unit 46 for converting the inputted offset-correcting signal DC0 received from the input end 472 into an analog signal. A first input end 482 of the adder 48 is coupled to an output end of the digital-to-analog converter 47, and a second input end 484 of the adder 48 is used for receiving an image signal SI. The adder 48 is used for adding the analog signals received by these two input ends 482 and 484 and outputting the result in an analog manner, where the image signal SI is an analog signal generated by the charge-coupled device.

The conventional signal compensation circuit 40 adds or subtracts an unique offset-correcting signal DC0 no matter which one of the charge-coupled devices is dealt with. As a result of the manufacturing process of charge-coupled devices, the characteristics of each charge-coupled device would differ from those of another, such that each charge-coupled device may require a different offset-correcting signal for eliminating the DC offset. If we use one single offset-correcting signal DC0 to deal with all the charge-coupled devices, this may cause signal errors and lower accuracy. Consequently, the resulting image may contain a straight-line phenomenon that reduces the quality of the resulting image.

### SUMMARY OF THE INVENTION

The present invention provides a signal compensation circuit for correcting DC offsets in an analog manner. The signal compensation circuit includes a storage unit, a multiplexer, and an arithmetic unit. The storage unit is used for storing a plurality of offset-correcting signals. The multiplexer includes at least two input ends coupled to the storage unit, each input end receiving one offset-correcting signal from the storage unit. The multiplexer includes at least one control end receiving a selector signal for selecting one of the received offset-correcting signals. A first input end of the arithmetic unit is coupled to an output end of the multiplexer for receiving the selected offset-correcting signal, and a second input end of the arithmetic unit receives the image signal. The arithmetic unit executes a compensation operation based on the analog signals received at the two input ends of the arithmetic unit. The image signal is a signal generated by an image sensor. The signal compensation circuit further includes a digital-to-analog converter having an input end coupled to the output end of the multiplexer. The digital-to-analog converter is used for converting the offset-correcting signal outputted from the multiplexer into an analog signal.

The present invention provides a method of correcting DC offsets in an analog manner. The method includes storing a plurality of offset-correcting signals, outputting from a multiplexer a offset-correcting signal chosen from the plurality of offset-correcting signals according to a selector signal, converting the offset-correcting signal outputted from the multiplexer into an analog offset-correcting signal, and executing a compensation operation with an arithmetic unit based on an image signal generated by an image sensor and the analog offset-correcting signal. The method further comprises using a digital-to-analog converter to convert the offset-correcting signal outputted from the multiplexer into an analog signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a conventional charge-coupled device.

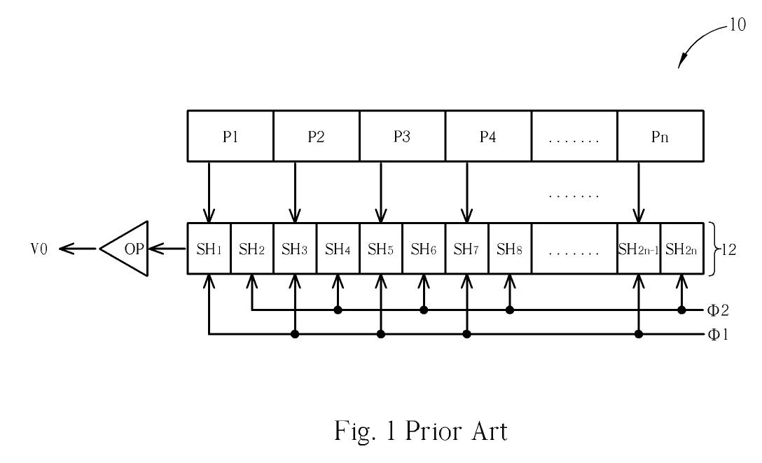

FIG. 2 is a structural drawing illustrating the plurality of shift register elements in FIG. 1.

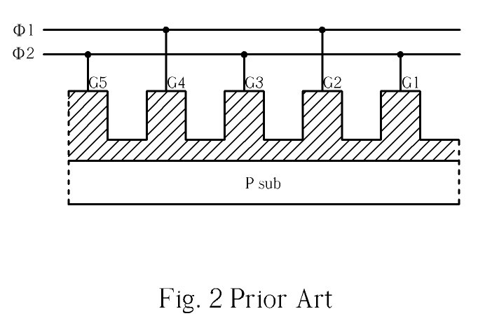

FIG. 3 is a diagram of a conventional even-odd charge-coupled device.

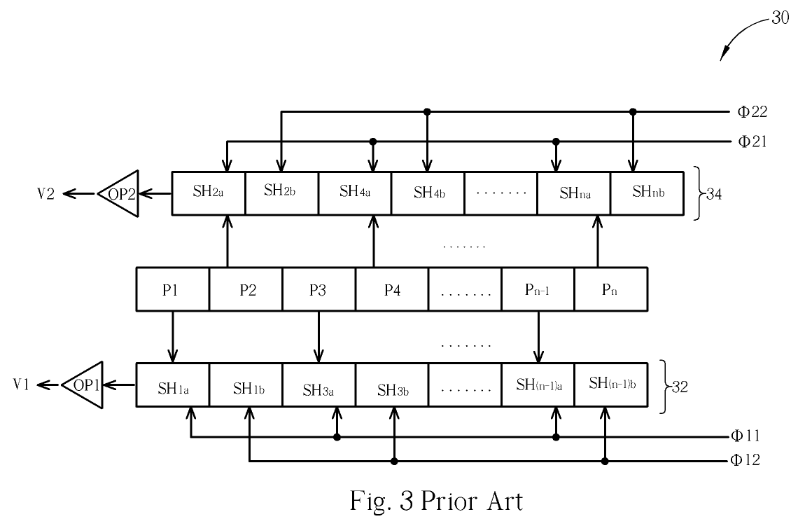

FIG. 4 is a diagram of a conventional signal compensation circuit.

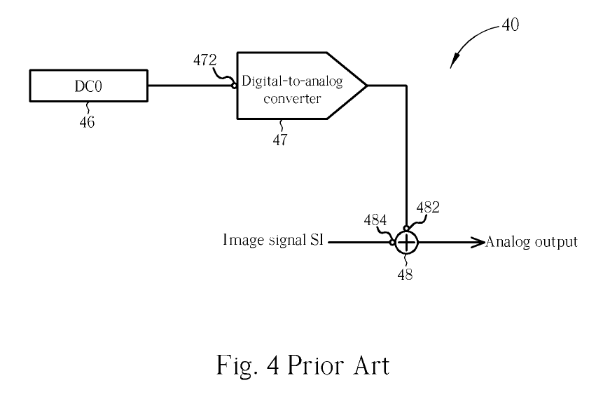

FIG. 5 is a diagram of a signal compensation circuit according to the present invention.

### DETAILED DESCRIPTION

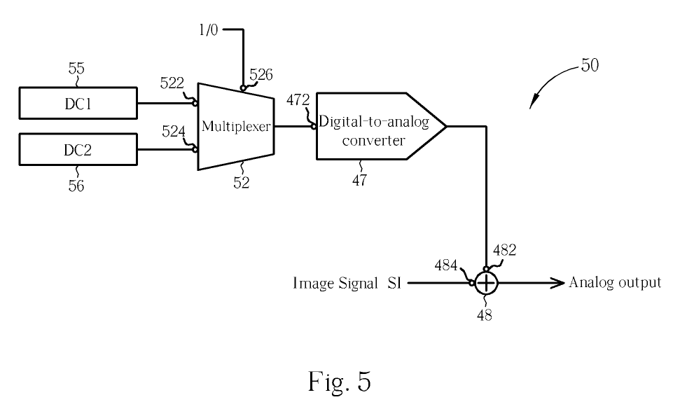

Please refer to FIG. 5 that is a diagram of a signal compensation circuit 50 according to the present invention. The signal compensation circuit 50 includes a first storage unit 55, a second storage unit 56, a multiplexer 52, a digital-to-analog converter 47, and an adder 48. The first storage unit 55 is used for storing an offset-correcting signal DC1, and the second storage unit 56 is used for storing another offset-correcting signal DC2. A first input end 522 of the multiplexer 52 is coupled to the first storage unit 55, and a second input end 524 of the multiplexer 52 is coupled to the second storage unit 56. The multiplexer 52 selects one of the offset-correcting signals DC1 and DC2 transmitted from these two storage units 55 and 56 and outputs the selected offset-correcting signal (DC1 or DC2) according to a selector signal of a control end 526 of the multiplexer 52. An input end 472 of the digital-to-analog converter 47 is coupled to an output end of the multiplexer 52. The digital-to-analog converter 47 is used for converting the offset-correcting signal outputted from the multiplexer 52 into an analog offset-correcting signal. A first input end 482 of the adder 48 is coupled to an output end of the digital-to-analog converter 47, and a second input end 484 of the adder 48 is used for receiving an image signal SI. The adder 48 is used for adding the analog offset-correcting signal and the image signal SI received by these two input ends 482 and 484 and outputting the result in an analog manner. The image signal SI is an analog signal generated by a charge-coupled device. The storage units 55 and 56 could be memory.

The above-mentioned embodiments illustrate but do not limit the present invention. The signal compensation circuit 50 includes two storage units 55 and 56 used for storing the offset-correcting signals DC1 and DC2. The capacity of the storage units is not restricted to a fixed number. The storage unit is not restricted to memory. The storage unit may be any other kind of storage device. Furthermore, the image signal SI is not limited to the signal generated by an interlaced charge-coupled device or an even-odd charge-coupled device. The present invention utilizes the adder 48 to add the image signal SI and the analog signal outputted from the digital-to-analog converter 47 but is not limited to the adder 48. The compensation operation can be executed based on the image signal SI and the analog signal outputted from digital-to-analog converter 47 by a subtractor or another arithmetic unit. If the offset-correcting signals DC1 and DC2 are in analog form, the digital-to-analog converter 47 could be omitted.

In conclusion, the present invention provides a signal compensation circuit for correcting DC offsets in an analog manner. And more particularly, the present invention provides a signal compensation circuit providing multiple offset-correcting signals respective for different charge-coupled devices, by using a plurality of storage units to store a plurality of the offset-correcting signals and a multiplexer 52, added in front of the digital-to-analog converter 47, to select a offset-correcting signal from the plurality of the offset-correcting signals according to a selector signal. The selector signal may be determined, for example, according to a reference table that correlates the offset-correcting signals and the individualities of the charge-coupled devices. Or the selector signal may be determined based on user's selection. The digital-to-analog converter 47 is used to convert the offset-correcting signal outputted from the multiplexer 52 into an analog signal. The analog signal and an image signal are added. The signal compensation circuit 50 compensates the image signal generated from any one of the plurality of charge-coupled devices with a different and correct offset-correcting signal, which improves the authenticity of the scan image and prevents a straight-line phenomenon from appearing. Furthermore, correcting DC offsets of charge-coupled devices in an analog manner could prevent quantification errors.

Those skilled in the art will readily observe that numerous modifications and alterations of the device and method may be made while retaining the teachings of the invention.

What is claimed is:

1. A signal compensation circuit for correcting DC offsets in an analog manner comprising:
a storage unit for storing a plurality of offset-correcting signals;
a multiplexer, having at least two input ends coupled to the storage unit, each input end receiving one of the offset-correcting signals from the storage unit, at least one control end receiving a selector signal for selecting one of the received offset-correcting signals and an output end outputting the selected offset-correcting signal; and
an arithmetic unit, having a first input end coupled to the output end of the multiplexer for receiving the selected offset-correcting signal and a second input end for receiving an image signal, the arithmetic unit executing a compensation operation using the selected offset-correcting signal and the image signal received at the two input ends of the arithmetic unit.

2. The signal compensation circuit of claim 1 wherein the arithmetic unit is an adder.

3. The signal compensation circuit of claim 1 wherein the arithmetic unit is a subtractor.

4. The signal compensation circuit of claim 1 wherein the storage unit comprises at least one memory.

5. The signal compensation circuit of claim 1 wherein the image signal is an analog signal generated by a charge-coupled device (CCD).

6. The signal compensation circuit of claim 1 further comprising a digital-to-analog converter having an input end coupled to the output end of the multiplexer, the digital-to-analog converter converting the selected offset-correcting signal outputted from the multiplexer into an analog offset-correcting signal.

7. A method of correcting DC offsets in an analog manner comprising:
storing a plurality of offset-correcting signals;
outputting from a multiplexer a offset-correcting signal chosen from the plurality of offset-correcting signals according to a selector signal;
converting the offset-correcting signal outputted from the multiplexer into an analog offset-correcting signal; and
executing a compensation operation with an arithmetic unit based on an image signal generated by an image sensor and the analog offset-correcting signal.

8. The method of claim 7 wherein the step of executing the compensation operation with the arithmetic unit based on the image signal generated by the image sensor and the analog offset-correcting signal is adding the image signal and the analog offset-correcting signal with the arithmetic unit.

9. The method of claim 7 wherein the step of executing the compensation operation with the arithmetic unit based on the image signal generated by the image sensor and the analog offset-correcting signal is subtracting the analog offset-correcting signal from the image signal with the arithmetic unit.

10. A method of correcting DC offsets in an analog manner comprising:
outputting from a multiplexer a offset-correcting signal chosen from a plurality of offset-correcting signals according to a selector signal; and
executing a compensation operation with an arithmetic unit based on an image signal generated by an image sensor and the offset-correcting signal outputted from the multiplexer.

11. The method of claim 10 wherein the step of executing the compensation operation with the arithmetic unit based on the image signal generated by the image sensor and the offset-correcting signal outputted from the multiplexer is adding the image signal and the offset-correcting signal outputted from the multiplexer with the arithmetic unit.

12. The method of claim 10 wherein the step of executing the compensation operation with the arithmetic unit based on the image signal generated by the image sensor and the offset-correcting signal outputted from the multiplexer is subtracting the offset-correcting signal outputted from the multiplexer from the image signal with the arithmetic unit.
